(19) United States
(12) Patent Application Publication
(10) Pub. No.: US 2022/0203752 A1
(43) Pub. Date: Jun. 30, 2022

(54) FOREVER STEM PEN AND HOLDER COMBINATION, APPARATUS, METHOD, AND A PROCESS THEREOF

(71) Applicant: Joseph Peraino, IV, Brooklyn, NY (US)

(72) Inventor: Gina Panella, Royal Palm Beach, FL (US)

(21) Appl. No.: 17/696,845

(22) Filed: Mar. 16, 2022

Related U.S. Application Data
(63) Continuation-in-part of application No. 16/405,554, filed on May 7, 2019.
(60) Provisional application No. 62/758,400, filed on Nov. 9, 2018.

(51) Int. Cl. B43K 29/00; B44C 5/06; A01G 5/06; A01N 3/00

(52) U.S. Cl. CPC B43K 29/00; A01N 3/00; A01G 5/06; B44C 5/06

(57) ABSTRACT

The invention is a forever stem pen and holder combination, apparatus, method, and a process thereof, and more particularly directed to a stem pen having a means to hold a natural preserved flower at a first end, and having a writing instrument at the second end. The natural preserved flower, such as, for example, a rose, where a natural or glycerin preserved rose or flower in a blooming state could be securely held for a longer period of time, such as, for example, longer than its natural decay or wilting time using the inventive stem. The forever stem pen could also be provided with at least one reservoir to accommodate at least one scented oil, which extends the fragrance capabilities of the natural preserved flower. The forever stem pen could also be provided with at least one slide resistance area or finger gripping area.

### CROSS-REFERENCE TO RELATED APPLICATIONS

The instant patent application is a Continuation-In-Part (CIP) of pending U.S. patent application Ser. No. 16/405,554, filed on May 7, 2019, titled “The Forever Stem, Apparatus, Method, And A Process Thereof,” which claims priority to and the benefit of U.S. Provisional Patent Application Ser. No. 62/758,400, filed on Nov. 9, 2018, titled “The Forever Stem, Apparatus, Method, And A Process Thereof,” the entire disclosure of each patent application is incorporated herein by reference.

### FIELD OF THE INVENTION

The invention is a forever stem pen and holder combination, apparatus, method, and a process thereof, and more particularly directed to a stem pen having a means to hold a natural preserved flower at a first end, and having a writing instrument at the second end. The natural preserved flower, such as, for example, a rose, where a natural or glycerin preserved rose or flower in a blooming state could be securely held for a longer period of time, such as, for example, longer than its natural decay or wilting time using the inventive stem. The forever stem pen could also be provided with at least one reservoir to accommodate at least one scented oil, which extends the fragrance capabilities of the natural preserved flower. The forever stem pen could also be provided with at least one slide resistance area or finger gripping area.

### BACKGROUND INFORMATION

Flower decoration, and preservation have been used in the industry for a variety of reasons, and many solutions have been introduced throughout the ages.

U.S. Pat. No. 3,158,524 (Duncan Tong), the entire disclosure of which is incorporated herein by reference, discloses an artificial floral display.

U.S. Pat. No. 3,928,936 (Dennis J. Wollen), the entire disclosure of which is incorporated herein by reference, discloses a flower holder wherein a chamber is formed within a housing and a liquid absorbent means contained within said housing, a plurality of deflectable protuberances located within said chamber and extending from the side wall of the chamber towards the center of the chamber, the stem of a flower to be inserted into said chamber and into contact with the absorbent material with the protuberances deflecting and frictionally binding into contact with the flower stem thereby holding the flower in position with respect to the housing, the housing being connected to a bendable wire in order to facilitate attachment of the flower holder to a corsage structure.

U.S. Pat. No. 4,082,872 (James L. Hughes), the entire disclosure of which is incorporated herein by reference, discloses a flower decoration which not only has a decorative effect but also is a useful table accessory. The decoration includes a base which provides a stable support for the sepal and flower portion of the flower. Means are provided for securing the sepal to the base such that the decoration in one embodiment incorporates a plurality of ashtrays as petals and in another embodiment is a candleholder.

U.S. Pat. No. 4,293,997 (Bobby L. Lee), the entire disclosure of which is incorporated herein by reference, discloses an artificial flower assembly which is made from a plastic stem unitarily molded around a reinforcing wire with integral side petioles (preferably wire reinforced) and an integral calyx and with a coupling member also integral therewith. The coupling member may be a stud having an enlarged terminal portion extending beyond the base of the calyx, or it may be a socket in the base of the calyx. Fabric leaves, in some species preferably with brown edging and impressed veining, are adhered to the petioles. A subassembly of fabric petals, preferably silk printed for veining where appropriate, is made by loosely mounting the petals on a plastic member, preferably tubular. The tubular member is then mounted on the coupling member. For example, it may be pushed on the stud until the enlarged terminal portion lies beyond the end of the tubular member, or it may be inserted in the socket, if that is used instead of the stud.

U.S. Pat. No. 5,120,583 (Pedro F. Garcia), the entire disclosure of which is incorporated herein by reference, discloses a composite flower assembly which includes a preserved natural flower head 37, a natural receptacle 46 and a natural pedicel segment 51, the flower head being securely fastened atop an artificial calyx 66 and secured to an artificial pedicel 33.

U.S. Pat. No. 5,145,730 (Peter S. C. Cheng), the entire disclosure of which is incorporated herein by reference, discloses a stemmed, flower-like decoration which is formed by folding strip regions of an elongated strip of flexible material about fold lines intersecting each other, and by overlapping the strip regions to impart a dish-shape to the folded strip. One or more dish-shaped strips are attached to a stem.

U.S. Patent Publication No. 20050103420 (Mei Hui Chen), the entire disclosure of which is incorporated herein by reference, discloses an attachment method for pressed flowers which includes the steps of: covering pressed flowers with a layer of transparent resin which becomes sticky when heated, attaching said pressed flowers to a surface of a base material, and indirectly heating said pressed flowers to make said resin become sticky thereby firmly adhering said pressed flowers to said base material without the use of adhesive and therefore making it easier and more convenient for decoration. It is also very convenient to separate the flower from the base material and heat it indirectly again to attach to another base material. The resin coating the flowers has the additional benefits of preventing the pressed flowers from color fading, wear and tear, and extending their usage.

This invention improves on the deficiencies of the prior art and provides an inventive forever stem pen and holder combination, apparatus, method, and a process thereof.

### PURPOSES AND SUMMARY OF THE INVENTION

The invention is a forever stem pen and holder combination, apparatus, method, and a process thereof.

Therefore, one purpose of this invention is to provide a stem pen that can securely hold a naturally preserved flower.

Another purpose of this invention is to provide a stem pen that can securely hold a glycerin preserved natural rose flower.

Yet another purpose of this invention is to provide a stem pen stand or holder that can securely, and removeably hold a forever stem pen.

Still yet another purpose of this invention is to provide a stem pen with a writing instrument at one end.

Yet another purpose of this invention is to provide a stem pen with at least one scent holding reservoir.

Therefore, in one aspect this invention comprises a natural preserved flower pen apparatus, comprising:
(a) a stem having a first end, and a second end, and wherein said second end having an opening to securely accommodate a short stem of a natural preserved flower, and wherein said first end having an opening to securely accommodate a writing instrument;
(b) a natural preserved flower head having a plurality of petals at a first end and said short stem at a second end, and wherein said short stem of said natural preserved flower head is securely held inside said second end of said stem; and
(c) a writing instrument having a first end and a second end, wherein said first end has a writing tip, and said second end has a reservoir containing writing fluid, and wherein said writing fluid flows into said writing tip, and wherein said writing instrument is securely held inside said first end of said stem.

In another aspect this invention comprises a scented natural preserved flower pen apparatus, comprising:
(a) a stem having a first end, and a second end, and wherein said second end having an opening to securely accommodate a short stem of a natural preserved flower, and wherein said first end having an opening to securely accommodate a writing instrument;
(b) a natural preserved flower head having a plurality of petals at a first end and said short stem at a second end, and wherein said short stem of said natural preserved flower head is securely held inside said second end of said stem;
(c) a writing instrument having a first end and a second end, wherein said first end has a writing tip, and said second end has a reservoir containing writing fluid, and wherein said writing fluid flows into said writing tip, and wherein said writing instrument is securely held inside said first end of said stem; and
(d) at least one scent reservoir between said first end and said second end of said stem, and wherein said short stem of said natural preserved flower head is in direct contact with said at least one scent reservoir, and wherein said scent reservoir contains at least one scented oil which supplies scent to said petals of said natural preserved flower head.

### BRIEF DESCRIPTION OF THE DRAWINGS

FIG. 1, illustrates a perspective view of a forever stem invention, according to a first embodiment of the invention.

FIG. 2, illustrates a perspective view of a forever stem invention, according to a second embodiment of the invention.

FIG. 3, illustrates a side view of a forever stem invention, according to a third embodiment of this invention.

FIG. 4, illustrates a top view of several short stem holder for the forever stem invention, according to another embodiment of this invention.

FIG. 5, illustrates a side view of a forever stem invention, according to a fourth embodiment of this invention.

FIG. 6, illustrates a front perspective view of a forever stem invention, according to a fifth embodiment of this invention.

FIG. 7, illustrates a cross-sectional front view of a forever stem pen invention, according to a sixth embodiment of this invention.

FIG. 8, illustrates a front perspective view of a forever stem pen stand invention, according to a seventh embodiment of this invention.

FIG. 9, illustrates a front perspective view of a forever stem pen and stand invention, according to an eighth embodiment of this invention.

FIG. 10, illustrates a front perspective view of a forever stem pen base stand invention, according to a ninth embodiment of this invention.

FIG. 11, illustrates a front perspective view of a forever stem pen and base stand invention, according to a tenth embodiment of this invention.

### DETAILED DESCRIPTION

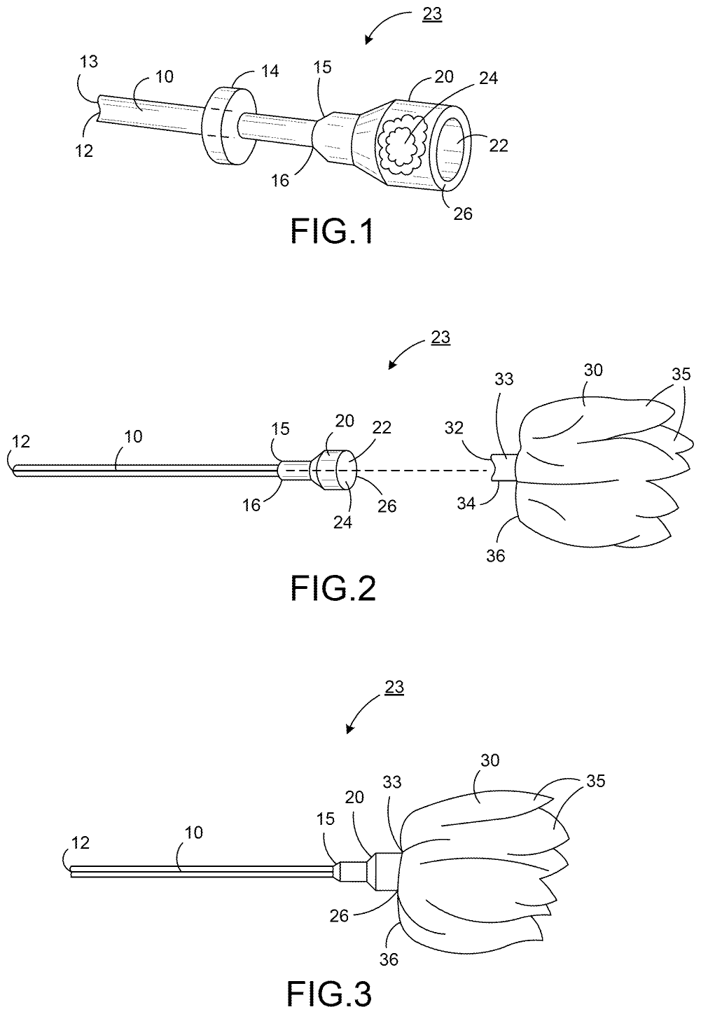

The inventive forever stem pen and holder combination, apparatus, method, and a process thereof will now be discussed with reference to FIGS. 1 through 11. Although the scope of the present invention is much broader than any particular embodiment, a detailed description of the preferred embodiment follows together with drawings. These drawings are for illustration purposes only and are not drawn to scale. Like numbers represent like features and components in the drawings.

It is well known that flowers, such as, for example, roses can be preserved using several different techniques. It is also well known that maintaining live roses requires a great deal of effort, while preserved roses will last indefinitely if properly preserved. It has been discovered that when preserving, for example, a rose in a blooming state, one should remove the leaves from the stem, and then the stem be removed or terminated so that a short stem of the flower or rose flower head is only left.

It should be further appreciated that glycerin can be used to preserve flowers, such as, for example, roses, and those preserved flowers can have a prolonged shelf life. Thus, depending on storage/environmental conditions, glycerin preserved flowers can last up to, for example, 6-12 months. However, some glycerin preserved flowers have been known to last up to years under certain conditions, such as, for example, in dry, and cool conditions. As a comparison, fresh cut flowers typically last 1 week, to 10 days, or less.

FIG. 1, illustrates a perspective view of a forever stem invention 23, according to a first embodiment of the invention. The forever stem invention 23, has a stem 10, such as, a metallic stem 10, having a first or bottom end 12, and a short stem holder 20, at the opposite or second end 16. For some applications the metallic stem 10, and the short stem holder 20, could be a single unit, while in other applications the metallic stem 10, could be secured to the short stem holder 20, using a joint, or connection, or transition 15. The metallic stem 10, could be hollow stem 10, having at least one hole or opening 13, or a solid stem 10, while the short stem holder 20, having an upper surface or lip or edge 26, is hollow and has at least one opening 22, or at least one blind hole 22, to accommodate at least one securing means 24, such as, for example, a short stem holding glue 24, or a securing clay 24, or an adhesive 24, to hold, and/or secure, for example, a short stem 33, of a flower 30, as shown more clearly in FIG. 2. For some applications the metallic stem 10, could be curved to mimic a natural flower or rose stem 10. Similarly, for some applications one could have an optional washer 14, or grommet 14, or similar such device 14, that could be rolled onto or slid onto the metallic stem 10, and which optional washer 14, could be used to securely hold the metallic stem 10, to another feature (not shown). For some applications, it is preferred that the metallic stem 10, is a substantially straight or a perpendicular metallic stem 10.

FIG. 2, illustrates a perspective view of a forever stem invention 23, according to a second embodiment of the invention. The flower or rose head 30, has a bottom or base 36, and a plurality of petals 35. The flower or rose head 30, has a short stem 33, having a stem end 32, and a stem securing area or region 34. The stem end 32, of the flower or rose head 30, is inserted into the blind hole or opening 22, of the short stem holder 20, and the stem 33, is secured therein using the stem securing area 34, via the at least one securing means 24, such as, for example, a short stem holding glue 24, or clay 24, or an adhesive 24, to name a few. It is preferred that the flower or rose head 30, is positioned on top of the short stem holder 20, so that the base 36, sits substantially flushed against the lip 26, of the short stem holder 20, as more clearly shown in FIG. 3.

FIG. 3, illustrates a side view of a forever stem invention 23, according to a third embodiment of this invention. The forever stem invention 23, has a rose or flower head 30, having the short stem 33, that is securely held inside the blind hole or opening 22, of the short stem holder 20, and is held onto the metallic stem 10, so that the combination could be sold as a flower or a rose 30, where the metallic stem 10, acts as a natural stem 10, or an artificial stem 10, while the preserved rose or flower head 30, acts as a natural rose 30, or flower head 30. For some applications it is preferred that the flower or rose head 30, is flush mounted to the short stem holder 20, such that the bottom surface of the base 36, is in physical contact with the lip or upper surface 26, so that the stem end 32, of the short stem of rose or flower head 33, is not visible, and is fully contained inside the blind hole or opening 22, and that only the base 36, of the natural rose 30, or flower head 30, is physically visible.

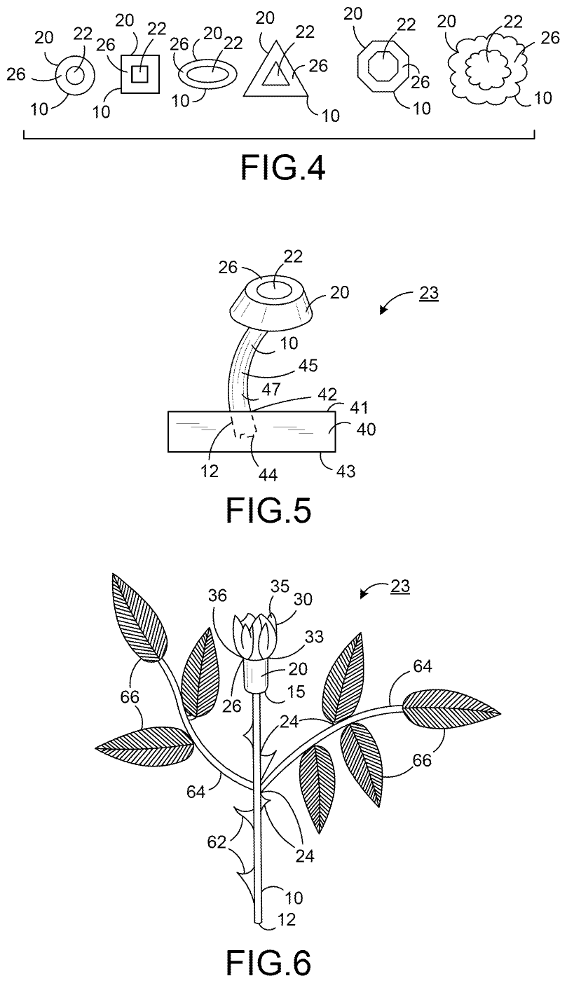

FIG. 4, illustrates a top view of several short stem holder 20, for the forever stem invention 23, according to another embodiment of this invention. As one can appreciate that the short stem holder 20, having at least one opening or blind hole 22, can have a variety of cross-sectional configurations, such as, for example, a circular cross-section, a square cross-section, a rectangular cross-section, an oval cross-section, a triangular cross-section, a multi-side cross-section, a polygonal cross-section, an odd cross-section, and combinations thereof, to name a few. Similarly, the stem 10, can have a variety of cross-sectional configurations, such as, for example, a circular cross-section, a square cross-section, a rectangular cross-section, an oval cross-section, a triangular cross-section, a multi-side cross-section, a polygonal cross-section, an odd cross-section, and combinations thereof, to name a few. Similarly, the upper surface or lip or edge 26, can have a variety of cross-sectional configurations, such as, for example, a circular cross-section, a square cross-section, a rectangular cross-section, an oval cross-section, a triangular cross-section, a multi-side cross-section, a polygonal cross-section, an odd cross-section, and combinations thereof, to name a few.

FIG. 5, illustrates a side view of a forever stem invention 23, according to a fourth embodiment of this invention. The forever stem invention 23, having the stem 10, the short stem holder 20, has the first or bottom end 12, securely held inside an opening or a blind hole 42, on a first or top surface or upper surface 41, of a base or holder or stem holder 40. The base or holder 40, has a bottom or second surface 43, which is used to place or hold the base or holder 40, on a display surface. For some applications, one could also use at least one securing means 44, such as, a glue 44, or an adhesive 44, to secure the end 12, of the stem 10, inside the opening or blind hole 42. For some applications one could also paint at least a portion of the metallic stem 10, with at least one coating 47. The at least one coating 47, could be a metallic coating 47, a non-metallic coating 47, a decorative coating 47, and combinations thereof, to name a few. The at least one coating 47, would give an illusion of a natural flower stem 10, or an unnatural or manmade or fancy flower stem 10, and wherein the color of the at least one coating 47, could be selected from a group comprising a green color, a brown color, a beige color, and combinations thereof, to name a few. For some applications the stem 10, could be made of a flexible material 45, a memory metal 45, a non-metallic material 45, a plastic material 45, and combinations thereof, to name a few.

FIG. 6, illustrates a front perspective view of a forever stem invention 23, according to a fifth embodiment of this invention. The forever stem invention 23, has a rose or flower head 30, having the short stem 33, that is securely held inside the blind hole or opening 22, of the short stem holder 20, and is held onto the metallic stem 10, so that the combination could be sold as a flower or a rose 30, where the metallic stem 10, acts as a natural stem 10, or an artificial stem 10, while the preserved rose or flower head 30, acts as a natural rose 30, or flower head 30. For some applications it is preferred that the flower or rose head 30, is flush mounted to the short stem holder 20, such that the bottom surface of the base 36, is in physical contact with the lip or upper surface 26, so that the stem end 32, of the short stem of rose or flower head 33, is not visible, and is fully contained inside the blind hole or opening 22, and that only the base 36, is physically visible. Furthermore, for some applications one could also have at least one artificial or natural preserved thorn 62, secured to the stem 10, using at least one glue or adhesive 24. Additionally, for some applications one could have at least one artificial or natural preserved branch 64, having at least one artificial or natural preserved leaf 66, secured to the metallic stem 10, using at least one glue or adhesive 24. For some applications glue or adhesive 24, could be used to secure the leaf 66, to the branch 64.

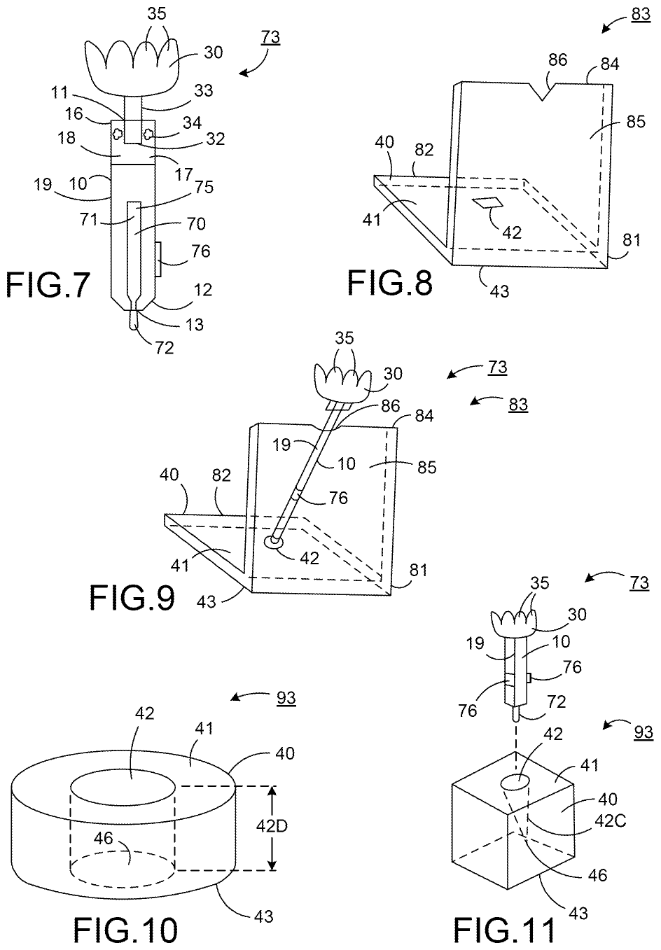

FIG. 7, illustrates a cross-sectional front view of a forever stem pen 73, invention, according to a sixth embodiment of this invention. The forever stem pen 73, has a stem 10, having a first or bottom end 12, and a second or top end 16. The first or bottom end 12, has a hole or opening 13, to accommodate a writing instrument 75, and the second or top end 16, has an opening or hole 11, to accommodate the short stem 33, of a naturally preserved flower 30, having petals 35. The writing instrument 75, has a writing tip 72, near the first or bottom end 12, of the forever stem pen 73, and an ink reservoir 70, containing writing fluid 71. The ink reservoir 70, is directly connected to the writing tip 72, and provides the writing fluid 71, to the writing tip 72. For some applications the forever stem pen 73, could be provided with a scent reservoir 17, near the second or top end 16, and wherein the scent reservoir 17, contains scented material 18, or scented oil 18. It should be appreciated that the scented material or scented oil 18, reaches the petal 35, via the short stem 33, as the base or end 32, of the short stem 33, faces or is in contact with the scent reservoir 17. For some applications a securing material 34, could be used to fixedly secure at least a portion of the short stem 33, inside the stem 10, at the top or second end 16. For some applications one could also have at least one slide resistance material 76, secured to at least a portion of the outer surface 19, of the stem 10. The slide resistance material 76, helps in gripping the forever stem pen 73, especially when the forever stem pen 73, is being used.

FIG. 8, illustrates a front perspective view of a forever stem pen stand 83, invention, according to a seventh embodiment of this invention. The forever stem pen stand 83, has a bottom panel or base 40, 82, an upper or first surface 41, a bottom or second surface 43, a blind hole 42, having a bottom or base 46, of the blind hole 42, as more clearly shown in FIG. 10. For some applications the base or bottom panel 40, 82, could have an upright wall or panel or portion 85, which would be connected to the base or bottom panel 40, 82, at an edge 81. In order to accommodate the outer peripheral surface 19, of the forever stem pen 73, a notch or indentation 86, could be provided along a top surface 84, of the upright wall 85

FIG. 9, illustrates a front perspective view of a forever stem pen 73, and a forever stem pen stand 83, invention, according to an eighth embodiment of this invention. As one can appreciate that the outer peripheral surface 19, of the forever stem pen 73, rests along a portion of the notch 86, while the writing tip portion 72, rests inside the blind hole 42.

FIG. 10, illustrates a front perspective view of a forever stem pen base stand 93, invention, according to a ninth embodiment of this invention. The forever stem pen base stand 93, has a bottom panel or portion or base 40, an upper or first surface 41, a bottom or second surface 43, a blind hole 42, having a bottom or base 46, of the blind hole 42. For the purposes of illustration, the forever stem pen base stand 93, has been shown having a round or elliptical or oval cross-section or shape. It should be appreciated that the blind hole 42, should have a depth 42D, to allow the forever stem pen 73, to securely, and removeably be able to stand substantially upright inside of the blind hole 42.

FIG. 11, illustrates a front perspective view of a forever stem pen 73, and forever stem pen base stand 93, invention, according to a tenth embodiment of this invention. The forever stem pen base stand 93, has a bottom panel or portion or base 40, an upper or first surface 41, a bottom or second surface 43, a blind hole 42, having a bottom or base 46, of the blind hole 42. For the purposes of illustration, the forever stem pen base stand 93, has been shown having a square or rectangular cross-section or shape. It should be appreciated that the blind hole 42, has a conical shape or cross-section 42C. As one can appreciate that the outer peripheral surface 19, of the forever stem pen 73, once inserted into the base or stem pen holder 40, would rest substantially vertically or upright in the base or stem pen holder 40, while the writing tip portion 72, would rests inside the conical blind hole 42C.

The material for the stem 10, of the natural preserved flower pen apparatus 73, could be selected from a group consisting of stainless steel material, copper material, brass material, aluminum material, wood material, plastic material, composite material, and combinations thereof.

The stem 10, of the inventive natural preserved flower pen apparatus 73, could have a coating of at least one material on at least a portion of the stem's outer surface 19, and wherein the at least one material could be selected from a group consisting of a metallic material, a non-metallic material, a decorative material, a rubber material, a plastic material, a composite material, and combinations thereof.

The cross-sectional shape of the stem pen base stand 93, could be selected from a group consisting of a circular cross-section, a square cross-section, a rectangular cross-section, an oval cross-section, a triangular cross-section, a multi-side cross-section, a polygonal cross-section, an odd-shape cross-section, and combinations thereof.

It is preferred that the rose or flower head 30, is in a state of bloom when it is preserved to be used with this invention, however, for some applications one could also use a pressed and preserved natural rose or flower head 30. Similarly, one or more of the leaf 66, is preferably a natural and preserved leaf 66, however, for some applications one could also use a pressed and preserved natural leaf 66.

The material for the metallic stem 10, could be selected from a group comprising, a stainless steel material, a copper material, a brass material, an aluminum material, a composite material, and combinations thereof, to name a few.

As stated earlier that the short stem 33, of the natural preserved flower head 30, is securely held inside the at least one blind hole 22, of the short stem holder 20, using at least one securing means 24, and wherein the at least one securing means 24, is selected from a group comprising of an adhesive, a glue, an epoxy, a resin, a bonding agent, a cement, a clay, and combinations thereof, to name a few.

For some applications the first end 12, of the stem 10, could be securely held inside a blind hole 42, of the base 40, using at least one securing means 44, and wherein the at least one securing means 44, could be selected from a group comprising of an adhesive, a glue, an epoxy, a resin, a bonding agent, a cement, a clay, and combinations thereof, to name a few.

It should be understood that the features recited in the description are interchangeable, and for the sake of convenience each of these inventive features are not repeated with the description of each feature.

It should be understood that the brief description of the invention is for illustration purposes only, and one could have other variations of this invention which are well known to a person skilled in the art.

Thus, the present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Still further, while certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

It should be further understood that throughout the specification and claims several terms have been used and they take the meanings explicitly associated herein, unless the context clearly dictates otherwise. For example, the phrase “in one embodiment” as used herein does not necessarily refer to the same embodiment, though it may. Additionally, the phrase “in another embodiment” as used herein does not necessarily refer to a different embodiment, although it may. Thus, various embodiments of the invention may be readily combined, without departing from the scope or spirit of the invention.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A natural preserved flower pen apparatus, comprising:
(a) a stem having a first end, and a second end, and wherein said second end having an opening to securely accommodate a short stem of a natural preserved flower, and wherein said first end having an opening to securely accommodate a writing instrument;
(b) a natural preserved flower head having a plurality of petals at a first end and said short stem at a second end, and wherein said short stem of said natural preserved flower head is securely held inside said second end of said stem; and
(c) a writing instrument having a first end and a second end, wherein said first end has a writing tip, and said second end has a reservoir containing writing fluid, and wherein said writing fluid flows into said writing tip, and wherein said writing instrument is securely held inside said first end of said stem.

2. The natural preserved flower pen apparatus of claim 1, wherein said stem has at least one scent reservoir between said first end and said second end to accommodate at least one scented oil.

3. The natural preserved flower pen apparatus of claim 1, wherein said stem has at least one scent reservoir between said first end and said second end to accommodate at least one scented oil, and wherein said stem of said natural preserved flower head is in direct contact with said at least one scent reservoir.

4. The natural preserved flower pen apparatus of claim 1, wherein said flower head is a rose flower head.

5. The natural preserved flower pen apparatus of claim 1, wherein material for said stem is selected from a group consisting of stainless steel material, copper material, brass material, aluminum material, wood material, plastic material, composite material, and combinations thereof.

6. The natural preserved flower pen apparatus of claim 1, wherein said stem has a coating of at least one material on at least a portion of said stem's outer surface.

7. The natural preserved flower pen apparatus of claim 1, wherein said stem has a coating of at least one material on at least a portion of said stem's outer surface, and wherein said at least one material is selected from a group consisting of a metallic material, a non-metallic material, a decorative material, a rubber material, a plastic material, a composite material, and combinations thereof.

8. The natural preserved flower pen apparatus of claim 1, wherein said short stem of said natural preserved flower head is securely held inside said at least one blind hole of said short stem holder using at least one securing means.

9. The natural preserved flower pen apparatus of claim 1, wherein said short stem of said natural preserved flower head is securely held inside said at least one blind hole of said short stem holder using at least one securing means, and wherein said at least one securing means is selected from a group consisting of an adhesive, a glue, an epoxy, a resin, a bonding agent, a cement, a clay, and combinations thereof.

10. The natural preserved flower pen apparatus of claim 1, wherein cross-section of said stem pen base stand is selected from a group consisting of a circular cross-section, a square cross-section, a rectangular cross-section, an oval cross-section, a triangular cross-section, a multi-side cross-section, a polygonal cross-section, an odd-shape cross-section, and combinations thereof.

11. The natural preserved flower pen apparatus of claim 1, wherein said natural preserved flower head having a short stem is preserved using glycerin.

12. The natural preserved flower pen apparatus of claim 1, wherein said first end of said stem is securely and removeably held inside a blind hole of a base stand.

13. The natural preserved flower pen apparatus of claim 1, wherein said stem has at least one slide resistant material secured thereto along at least a portion of said stem's outer surface.

14. The natural preserved flower pen apparatus of claim 1, wherein said stem is provided with a forever stem pen base stand to securely and removeably hold said tip portion of said writing instrument.

15. The natural preserved flower pen apparatus of claim 14, wherein said forever stem pen base stand has a blind hole to securely and removeably hold said tip portion of said writing instrument.

16. The natural preserved flower pen apparatus of claim 14, wherein said forever stem pen base stand has a conical shaped blind hole to securely and removeably hold said tip portion of said writing instrument.

17. The natural preserved flower pen apparatus of claim 14, wherein an outer peripheral cross-section of said forever stem pen base stand is selected from a group consisting of a circular cross-section, a square cross-section, a rectangular cross-section, an oval cross-section, a triangular cross-section, a multi-side cross-section, a polygonal cross-section, an odd-shape cross-section, and combinations thereof.

18. The natural preserved flower pen apparatus of claim 1, wherein said stem is provided with a forever stem pen base to securely and removeably hold said tip portion of said writing instrument, and wherein said forever stem pen base has an upright wall secured thereto along an edge.

19. The natural preserved flower pen apparatus of claim 18, wherein said upright wall has at least one notch on its upper peripheral portion to accommodate an outer peripheral surface portion of said stem.

20. A scented natural preserved flower pen apparatus, comprising:
(a) a stem having a first end, and a second end, and wherein said second end having an opening to securely accommodate a short stem of a natural preserved flower, and wherein said first end having an opening to securely accommodate a writing instrument;
(b) a natural preserved flower head having a plurality of petals at a first end and said short stem at a second end, and wherein said short stem of said natural preserved flower head is securely held inside said second end of said stem;
(c) a writing instrument having a first end and a second end, wherein said first end has a writing tip, and said second end has a reservoir containing writing fluid, and wherein said writing fluid flows into said writing tip, and wherein said writing instrument is securely held inside said first end of said stem; and
(d) at least one scent reservoir between said first end and said second end of said stem, and wherein said short stem of said natural preserved flower head is in direct contact with said at least one scent reservoir, and wherein said scent reservoir contains at least one scented oil which supplies scent to said petals of said natural preserved flower head.
